(19) United States
(12) Patent Application Publication
(10) Pub. No.: US 2025/0100907 A1
(43) Pub. Date: Mar. 27, 2025

(54) REMOVING BIVALENT IONS FROM PRODUCED WATER

(71) Applicant: Saudi Arabian Oil Company, Dhahran (SA)

(72) Inventors: Andrey Kovalskii, Moscow (RU); Anton Manakhov, Moscow (RU); Madina Baltaeva, Moscow (RU); Maxim Orlov, Moscow (RU); Fahd Ibrahim AlGhunaimi, Dhahran (SA); Norah Aljuryyed, Dhahran (SA)

(21) Appl. No.: 18/475,317

(22) Filed: Sep. 27, 2023

(51) Int. Cl. C02F 1/44; B01D 61/02; B01D 65/02; B01D 67/00; B01D 71/28; C02F 101/10; C02F 103/10; C08J 7/12

(52) U.S. Cl. CPC C02F 1/442; B01D 61/027; B01D 65/02; B01D 67/00042; B01D 67/009; B01D 71/281; C08J 7/123; B01D 2321/162; B01D 2321/30; B01D 2321/35; B01D 2323/36; B01D 2323/39; C02F 2101/10; C02F 2103/10; C02F 2303/16; C08J 2325/06

(57) ABSTRACT

A system and a method for purifying a produced water using a nanomembrane formed from polymeric waste are provided. The method includes placing the nanomembrane into an aqueous solution, wherein a surface of the nanomembrane is functionalized with carboxyl groups. Carbon dioxide is injected into the aqueous solution, and bivalent alkaline earth cations are adsorbed on the surface of the nanomembrane in the presence of carbonate ions (CO₃²⁻) to form carbonate crystals on the surface of the nanomembrane.

### TECHNICAL FIELD

This disclosure relates to a system and a method for removing bivalent alkaline earth ions from produced water during oil production.

### BACKGROUND

Bivalent ions, such as alkaline earth ions, are often found at high concentrations in produced water. These ions can react with carbonates to form scale, causing problems with downstream units and piping. Further, disposal of solutions with high concentrations of alkaline earth ions can be environmentally problematic and may be limited by environmental rules. The presence of these ions also interferes with the reuse of the produced water in oil field applications, as they can cause the precipitation of other oilfield chemicals.

Various methods of wastewater treatment have been used to remove impurities, such as bivalent cations. These include reverse osmosis, adsorbents, and other systems. Solid adsorbents have been used as media in column beds for the removal of bivalent cations from wastewater.

### SUMMARY

An embodiment described herein provides a method directed to purifying a produced water using a nanomembrane formed from polymeric waste. The method includes placing the nanomembrane into an aqueous solution, wherein a surface of the nanomembrane is functionalized with carboxyl groups. Carbon dioxide is injected into the aqueous solution, and bivalent alkaline earth cations are adsorbed on the surface of the nanomembrane a solution including carbonate ions (CO₃²⁻) to form carbonate crystals on the surface of the nanomembrane.

Another embodiment described herein provides a system for a functionalized membrane for adsorbing bivalent cations. The system includes a carrier including fibers with a high specific surface area, carboxyl groups attached on the surface of the fibers, and a mount to hold the carrier in a wastewater stream.

### BRIEF DESCRIPTION OF DRAWINGS

FIG. 1 is a drawing of a system for adsorbing bivalent ions from produced water stream.

FIGS. 2A-2E are schematic diagrams of the purification of wastewater by using a nanomembrane to adsorb bivalent alkaline earth cations through the formation of carbonates.

FIGS. 3A and 3B are schematic drawing of the modification of a polymer surface with a CO₂ plasma treatment.

FIG. 4 is a block flow diagram of a method for removing bivalent alkaline earth ions from produced water using a nanomembrane created from polymeric waste.

FIG. 5 is a block diagram of a method for creating a nanomembrane from polymeric waste.

### DETAILED DESCRIPTION

Embodiments described herein provide a system and a method for removing bivalent alkaline earth cations (Mg²⁺, Ca²⁺, Sr²⁺, Ba²⁺) from wastewater, such as produced water. The system includes a nanofiber-based membrane or nanomembrane, for example, made from polystyrene. The nanomembrane has a high specific surface area. The surface of the nanomembrane is functionalized to have carboxyl groups to increase the adsorption of the alkaline earth cations. The nanomembrane is placed in the wastewater and a CO₂ stream is introduced. The alkaline earth cations are adsorbed, and carbonate crystals are formed on the surface. The system may further include a stage for membrane regeneration with concentration of bivalent alkaline earth metals.

The methods include creating nanofiber-based membranes (nanomembranes) from polymeric waste, including expanded polystyrene, polyacrylonitrile and others. The nanomembranes are treated with CO₂ plasma using low-pressure or atmospheric discharges. The treated nanomembranes are placed in wastewater or produced water, such as in a tank or a stream of the wastewater, and carbon dioxide (CO₂) is injected into the water. The carbonates of bivalent alkaline earth metals are forming on the surface of the nanomembranes and the nanomembranes are removed from the wastewater. As used herein, the use of the term “carbonates” includes bicarbonates and bicarbonates attached to the metal surface. After the formation of the carbonates, the nanomembrane is regenerated, for example, by acid treatment, mechanical agitation, or both. The regenerated nanomembrane can then be reused.

The cleaning of produced water from bivalent ions can be performed by membrane nano-filtration process. In order to induce the adsorption of ions of bivalent alkaline earth metals by high-porous material of membrane, surface functionalization with —COOH groups is required. Such functionalization can be achieved in various ways including acidic treatment, laser ablation, or plasma treatment, among other. The most effective sustainable process will be the utilization of CO₂ plasma treatment that allows both modify the surface and utilize CO₂. The creation of a highly porous nanomembrane from the conversion of plastic waste, such as polystyrene, provides significant economic benefits, reduces in CO₂ emissions, and reduces chemical waste.

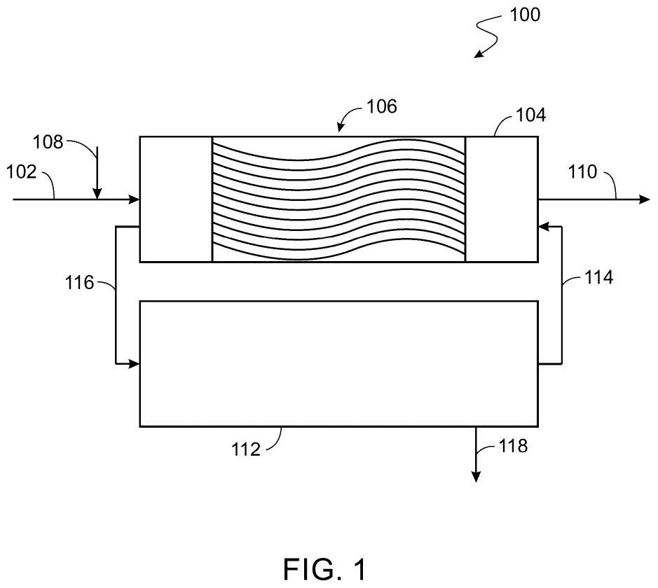

FIG. 1 is a drawing of a system 100 for adsorbing bivalent ions from produced water stream. In the example of FIG. 1, a produced water stream 102 is flowed into a carrier 104 that holds a functionalized nanomembrane 106. In various embodiment, the functionalized nanomembrane 106 is made from polymeric waste, such as expanded polystyrene, polyacrylonitrile or polymeric material that can be dissolved in a solvent, for example, for electrospinning of nanofibers. As described herein, the nanofibers are formed into a nanomembrane, and the surface of the nanomembrane is modified by carbonyl groups.

A stream of CO₂ 108 is introduced to the produced water. The bivalent ions react with the CO₂ and crystalize on the nanomembrane to form a carbonate. A purified water stream 110 exits the carrier 104.

As the bivalent ions are removed, the nanomembrane 106 forms a coating of carbonate crystals, which eventually fouls the nanomembrane 106, lowering the flowrate through. Accordingly, the system 100 includes a tool 112 to regenerate the nanomembrane 106. The tool 112 may include an acid wash system that sends an acid stream 114, for example, including HCl, through the carrier 104 and the nanomembrane 106. A return stream 116 contains the dissolved bivalent ions, and CO₂ gas. A waste stream 118 can remove these materials from the tool 112, for recovery for other uses. In some embodiments, the tool 112 includes a device to add mechanical energy to the nanomembrane 106 during cleaning, such as an ultrasonic transducer. Depending on the concentration of dissolved bivalent cations, nanomembranes may be used in parallel arrangements to increase the efficiency of the purification process.

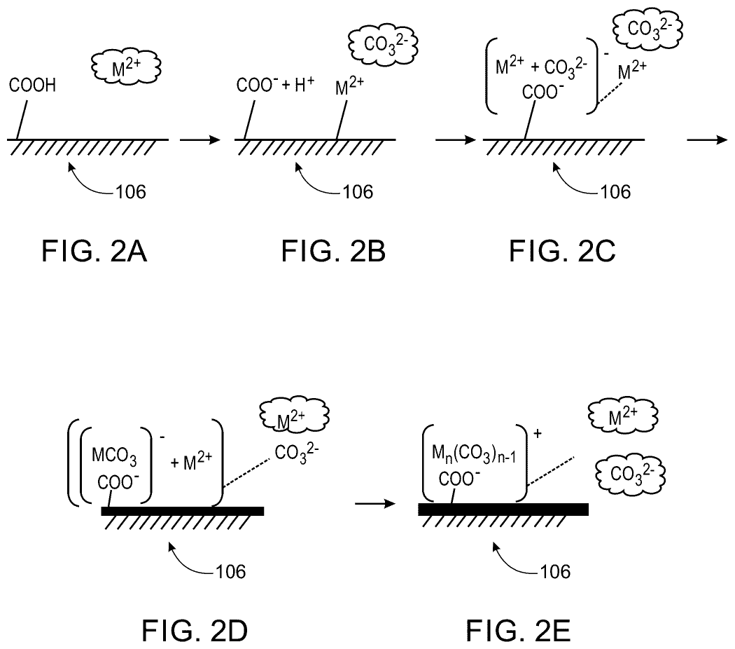

FIGS. 2A-2E are schematic diagrams of the purification of wastewater by using a nanomembrane 106 to adsorb bivalent alkaline earth cations through the formation of carbonates. In these figures, M²⁺ represents the bivalent metal ion, e.g., Mg²⁺, Ca²⁺, Sr²⁺, Ba²⁺, or mixture of these ions. The functionalized nanomembranes are placed in a stream or storage tank containing wastewater or produced water.

As shown in FIG. 2A, in an aqueous solution, the carboxyl groups on the surface of membrane dissociate into COO⁻ and H⁺ in accordance with the following reaction:

$$COOH ↔ {COO}^{-} + {H}^{+} \qquad ( 1 )$$

As shown in FIG. 2B, the bivalent alkaline earth cations, M²⁺, or adsorbed from the wastewater onto the surface of the functionalized membrane. A stream of carbon dioxide (CO₂) is blown through the wastewater. Carbon dioxide is dissolved in water to form carbonic acid (H₂CO₃) in accordance with the following reaction:

$${CO}_{2} + {H}_{2} O ↔ {H}_{2} {CO}_{3} \qquad ( 2 )$$

which, in turn, dissociates in two stages according to the following reactions:

$${H}_{2} {CO}_{3} ↔ {H}^{+} + {HCO}_{3}^{-} \qquad ( 3 )$$

$${HC O}_{3}^{-} ↔ {H}^{+} + {CO}_{3}^{2 -} \qquad ( 4 )$$

Thus, during dissociation of the carbonic acid by the second stage, carbonate ions (CO₃²⁻) are formed in slightly alkaline conditions. As shown in FIG. 2C, during the interaction of alkaline earth cations (M²⁺) adsorbed on the membrane and COO⁻ functional groups, in the presence of carbonate ions in solution, carbonates or bicarbonates of alkaline earth metals crystallize on the surface of the nanomembrane 106. As a result, a negative charge is formed on the surface of the nanomembrane 106.

As shown in FIG. 2D, as a result of the negative charge another alkaline earth cation (M²⁺) is adsorbed onto the nanomembrane 106 from the solution and a new portion of carbonate is formed. The resulting surface charge is then positive. As shown in FIG. 2E, another carbonate ion interacts with the carbonate and the surface becomes negatively charged again. The iteration of these processes causes a constant growth of carbonate on the membrane surface until one of the components involved in the interaction is depleted.

The rate and efficiency of extraction of alkaline earth metals from a solution primarily depends on the specific surface area of the nanomembrane 106 acting as a substrate and the type of alkaline earth cation. Further factors the controller reaction are the composition of the initial wastewater and the physicochemical conditions of the process. Depending on the type of bivalent cation, the optimal physicochemical parameters of crystallization may vary. The nanomembrane 106 with the crystallized carbonate layer can be regenerated, as discussed with respect to FIG. 1. For example, the nanomembrane 106 can be removed from a solution, tank, or flowing waste stream, and the crystallized carbonate layer can be recycled. The nanomembrane 106 can then be regenerated by treatment in a hydrochloric acid solution with a concentration in the interval 10-20%, for example, with mechanical agitation, such as flowing the acid stream, treating the fouled nanomembrane 106 with ultrasonic energy, poor stirring the nanomembrane 106 in the acid solution, among other techniques. After regeneration, the nanomembrane 106 can be reused for adsorption of bivalent alkaline earth cations.

Using the system and method described herein, the purification of water contaminated with alkaline earth ions can be controlled and scaled. Further, the alkaline earth metals can be purified for reuse. The use of polymeric waste and carbon dioxide also utilizes that waste materials that might otherwise be disposed.

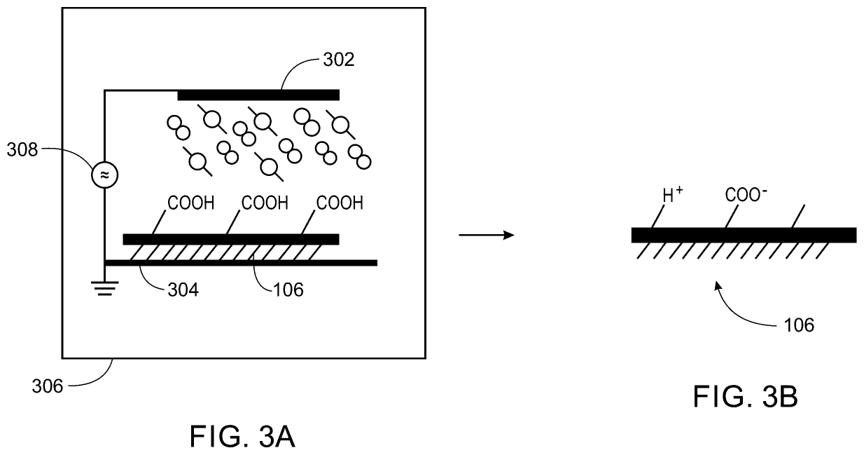

FIGS. 3A and 3B are schematic drawing of the modification of a polymer surface with a CO₂ plasma treatment. In order to increase the adsorption properties of a nanomembrane 106, the surface of the nanomembrane 106 is modified using a CO₂ plasma treatment. As shown in FIG. 3A, the nanomembrane 106 is placed below an electrode 302 on a ground plane 304, for example, in a plasma treatment chamber 306. The pressure in the plasma treatment chamber 306 can be adjusted to near vacuum conditions to allow the formation of the plasma. In some embodiments, the power for the plasma treatment is supplied by a high-frequency generator 308 with a power of about 0.5 to about 3 kW. The duration of treatment depends on the applied power of the high-frequency generator 308. Generally, the nanomembrane 106 surface processing time is less than about 15 minutes and in accordance with the generator power supply and can vary from 5 to 15 minutes with a power of 3 to 0.5 kW, respectively. As a result of this treatment, the surface of the nanomembrane 106 is functionalized with carboxyl groups (COOH).

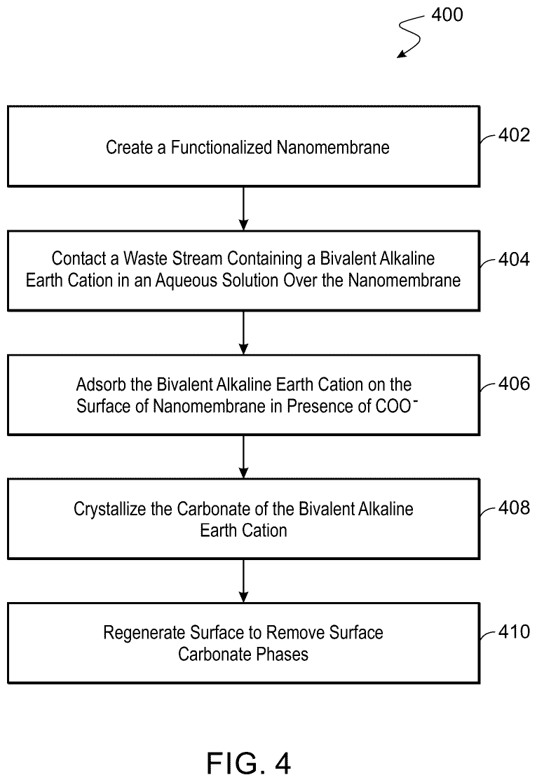

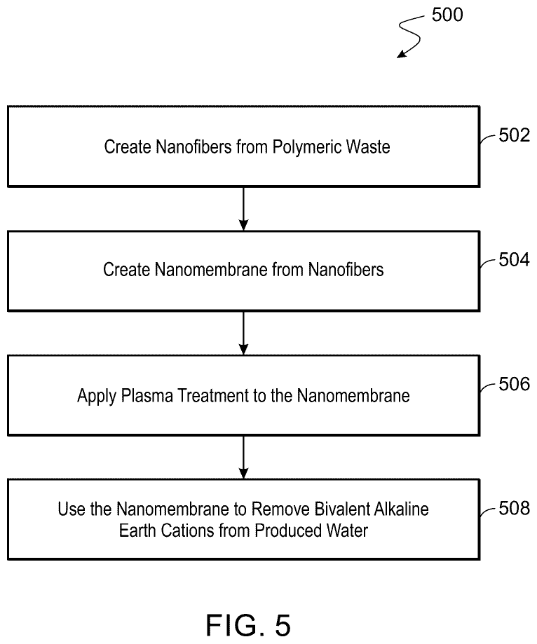

FIG. 4 is a block flow diagram of a method 400 for removing bivalent alkaline earth ions from produced water using a nanomembrane created from polymeric waste. The method starts at block 402, with the creation of a functionalized nanomembrane. In some embodiments, this is performed as described with respect to FIG. 5. In other embodiments, fibers are formed from a liquid extrusion process using a spinneret and used to form the membrane in a nonwoven fabric process. The nanomembrane is then plasma treated with carbon dioxide to form carbonates on the surface.

At block 404, a waste stream containing a bivalent alkaline earth cation in an aqueous solution is contacted with the nanomembrane, for example by flowing a produced water stream over the nanomembrane or placing the nanomembrane in a storage tank. The wastewater is saturated with CO₂ gas. In the wastewater, the carboxyl groups on the surface of the nanomembrane dissociates into COO⁻ and H⁺. At block 406, the bivalent alkaline earth cation is adsorbed on the surface of nanomembrane in the presence of carbonate ions (CO₃²⁻). At block 408, the bivalent alkaline earth cation forms a layer of alkaline earth metal carbonates, bicarbonates, or both, is formed, which later serve as a seed for the crystallization of carbonates (and/or bicarbonates) from the solution. At block 410, the surface of the nanomembrane is regenerated to remove the surface carbonate phases.

FIG. 5 is a block diagram of a method for creating a nanomembrane from polymeric waste. At block 502, nanofibers are created from polymeric waste. For example, by electrospinning of polystyrene or other polymer from a suitable solvent. As a result of the adsorption of bivalent alkaline earth cations (Mg²⁺, Ca²⁺, Sr²⁺, Ba²⁺) on the developed surface of the membrane, during the interaction with COO⁻ groups in the presence of CO₃²⁻. The nano fibers may also be created by molding from melt or solution, leaching of filler, sintering of powders, partial dissolution of polymer, as well as modification of previously manufactured membranes. The material used to create the nanomembrane's is a polymeric waste of packaging and insulation materials (expanded polystyrene, polyacrylonitrile or other soluble polymeric material).

At block 504, a nanomembrane is created from the nano fibers. For example, this may be performed by creating a nonwoven fabric from the nano fibers using heat and rollers to fuse the loose nano fibers into the nanomembrane.

At block 506, the nanomembranes can be treated with CO₂ plasma using low-pressure or atmospheric pressure discharges. This functionalized the surface with carboxyl groups.

As described above, at block 508, after functionalization, the nanomembrane is placed into wastewater or produced water to convert the carboxyl functional groups on the nanomembrane to carbonic acid groups. Carbon dioxide is injected into the wastewater, and the bivalent alkaline earth cations are removed by carbonates formation on the surface of the nanomembrane.

### Embodiments

An embodiment described herein provides a method directed to purifying a produced water using a nanomembrane formed from polymeric waste. The method includes placing the nanomembrane into an aqueous solution, wherein a surface of the nanomembrane is functionalized with carboxyl groups. Carbon dioxide is injected into the aqueous solution, and bivalent alkaline earth cations are adsorbed on the surface of the nanomembrane in a solution including carbonate ions (CO₃²⁻) to form carbonate crystals on the surface of the nanomembrane.

In an aspect, combinable with any other aspect, the method includes forming nanofibers from the polymeric waste. In an aspect, the method includes forming a nanomembrane from the nanofibers.

In an aspect, combinable with any other aspect, the method includes plasma treating the nanomembrane to functionalize the nanomembrane with carboxyl groups.

In an aspect, combinable with any other aspect, the method includes regenerating the nanomembrane by dissolving carbonate crystals in a hydrochloric acid solution.

In an aspect, combinable with any other aspect, the method includes regenerating the nanomembrane by mechanical treatment. In an aspect, the mechanical treatment includes subjecting the nanomembrane to sonication.

In an aspect, combinable with any other aspect, the method includes electrospinning the polymeric waste into nanofibers. In an aspect, the method includes forming the nanomembrane by fusing the nanofibers together.

In an aspect, combinable with any other aspect, the polymeric waste is polystyrene.

In an aspect, combinable with any other aspect, the method includes functionalizing the surface of the nanomembrane by a CO₂ plasma treatment. In an aspect, the CO₂ plasma treatment includes a low-pressure discharge. In an aspect, the CO₂ plasma treatment includes treating the nanomembrane using a plasma equipment. In an aspect, the method includes forming carboxyl groups on the surface of the nanomembrane.

In an aspect, combinable with any other aspect, the method includes placing the nanomembrane in a wastewater stream.

In an aspect, combinable with any other aspect, the method includes placing the nanomembrane in a wastewater tank.

Another embodiment described herein provides a system for a functionalized membrane for adsorbing bivalent cations. The system includes a carrier including fibers with a high specific surface area, carboxyl groups attached on the surface of the fibers, and a mount to hold the carrier in a wastewater stream.

In an aspect, combinable with any other aspect, the system includes a mechanical treater to regenerate the membrane and recover bivalent alkaline earth elements.

In an aspect, combinable with any other aspect, the system includes a hydrochloric acid solution to dissolve residual carbonates from the membrane.

Other implementations are also within the scope of the following claims.

What is claimed is:

1. A method directed to purifying a produced water using a nanomembrane formed from polymeric waste, comprising:
placing the nanomembrane into an aqueous solution, wherein a surface of the nanomembrane is functionalized with carboxyl groups;
injecting carbon dioxide into the aqueous solution; and
adsorbing bivalent alkaline earth cations on the surface of the nanomembrane in a solution comprising carbonate ions (CO₃²⁻) to form carbonate crystals on the surface of the nanomembrane.

2. The method of claim 1, comprising forming nanofibers from the polymeric waste.

3. The method of claim 2, comprising forming a nanomembrane from the nanofibers.

4. The method of claim 1, comprising plasma treating the nanomembrane to functionalize the nanomembrane with carboxyl groups.

5. The method of claim 1, comprising regenerating the nanomembrane by dissolving carbonate crystals in a hydrochloric acid solution.

6. The method of claim 5, comprising regenerating the nanomembrane by mechanical treatment.

7. The method of claim 6, wherein the mechanical treatment comprises subjecting the nanomembrane to sonication.

8. The method of claim 1, comprising electrospinning the polymeric waste into nanofibers.

9. The method of claim 8, comprising forming the nanomembrane by fusing the nanofibers together.

10. The method of claim 1, wherein the polymeric waste is polystyrene.

11. The method of claim 1, comprising functionalizing the surface of the nanomembrane by a CO₂ plasma treatment.

12. The method of claim 11, wherein the CO₂ plasma treatment comprises a low-pressure discharge.

13. The method of claim 12, wherein the CO₂ plasma treatment comprises treating the nanomembrane using a plasma equipment.

14. The method of claim 13, comprises forming carboxyl groups on the surface of the nanomembrane.

15. The method of claim 1, comprising placing the nanomembrane in a wastewater stream.

16. The method of claim 1, comprising placing the nanomembrane in a wastewater tank.

17. A system for using a functionalized membrane for adsorbing bivalent cations, comprising:
a carrier comprising fibers with a high specific surface area;
carboxyl groups attached on the surface of the fibers; and
a mount to hold the carrier in a wastewater stream.

18. The system of claim 17, comprising a mechanical treater to regenerate the membrane and recover bivalent alkaline earth elements.

19. The system of claim 18, comprising a hydrochloric acid solution to dissolve residual carbonates from the membrane.
